(19) United States
(12) Patent Application Publication
(10) Pub. No.: US 2005/0260302 A1
(43) Pub. Date: Nov. 24, 2005

(54) Nutritionally balanced traditional snack foods having a low glycemic response

(75) Inventor: Robert Lawrence Prosise, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/848,717

(22) Filed: May 19, 2004

(51) Int. Cl. A23L 1/30

(52) U.S. Cl. 426/72

(57) ABSTRACT

Disclosed are nutritious, low glycemic index and/or low glycemic load snacks. These snacks offer an alternative to appealing but unhealthy snacks. The nutritious snacks of the present invention are traditional in form, provide a balanced mix of an amino acid source, fat, fiber and low glycemic index carbohydrates and typically have an appeal similar to that of unhealthy snacks of similar form. Thus, the snacks of the present invention resolve the dilemma that consumers are currently faced with—healthy eating or enjoying what you eat. Processes for making the appealing traditional nutritious low glycemic index and/or low glycemic load snacks are also disclosed.

### FIELD OF THE INVENTION

The present invention relates to nutritious snack compositions. More specifically, the present invention relates to snacks compositions having balanced nutritional profiles that exhibit a relatively low glycemic index and/or low glycemic load. Processes for making the compositions are also disclosed.

### BACKGROUND OF THE INVENTION

It is common for snacks to be convenient and tasty but unhealthy, like candy bars, cheese crackers, and similar traditional snacks; inconvenient to prepare or perishable like fruits and vegetables; or nutritious and convenient but organoleptically unappealing like health foods. Due to health concerns, many consumers initially turn to health food bars or drinks but, due to the undesirable flavor, texture or appearance of these products, soon find themselves replacing these products with traditional snacks.

Although traditional snacks are appealing, they have a negative impact on the physical and mental health of consumers. In particular, it is appreciated that the high fat and calorie load and low dietary fiber level of traditional snacks can contribute to obesity and many of the chronic diseases, such as coronary heart disease, stroke, diabetes, and certain types of cancer. Furthermore, traditional snacks can cause major blood sugar swings due to their high level of refined carbohydrates. This major impact on blood sugar increases appetite and causes people to eat more, leading to obesity.

It is known that many consumers prefer traditional snacks to nutritious foods. It is also known that consumers associate the form of a snack food with the enjoyment of the eating experience. Thus, consumers are more likely to consume a snack that is nutritious, and thereby obtain the benefits of the nutritious snack, when the nutritious snack is similar, at least in form, to an appealing but unhealthy traditional snack. In short, many consumers associate snack appeal with snack form. As a result, what is needed is one or more snack foods having balanced nutritional profiles, having minimal impact on blood sugar, and the form of a traditional snack.

Unfortunately, numerous technical obstacles have blocked the development of nutritionally balanced traditional snacks. In particular, most previous attempts at producing said snacks have resulted in products that have poor textures, tastes and appearances.

Notwithstanding the technical hurdles associated with providing such snacks, U.S. patent Publication Nos. 2002/0015760A1 , 2002/0034574A1, 2002/0094359A1, 2002/0015761A1, 2002/0012722A1, 2002/0015759A1 and 2002/0012733A1, all published by Prosise et al., describe various good tasting, healthy snack foods that represent a significant advancement over the prior art. While the compositions described in those publications provide very useful and desirable snack foods, there is no discussion of the additional benefit of having snack foods that exhibit a relatively low glycemic index. Such products provide additional benefits of reducing the impact of the product on blood sugar when eaten, which has additional benefits of reducing hunger, and being acceptable by diabetics.

Through additional research, Applicant has surprisingly developed snack foods that, in addition to having relatively high levels of protein and fiber and relatively low levels of fat, exhibit a relatively low glycemic index and/or low glycemic load.

### SUMMARY OF THE INVENTION

In one aspect, the present invention relates to nutritionally balanced snack foods having water activities less than 0.90 and comprising, on a 30-gram reference basis:

a) a glycemic index of not more than about 55, or a glycemic load of not more than about 6, or both;

b) at least about 5 g of amino acid source;

c) not more than about 3 g of digestible fat; and

d) a carbohydrate that provides at least about 2.5 g of dietary fiber.

The present invention also concerns snack foods having water activities less than 0.90 and comprising, on a 100 kcal reference basis:

a) a glycemic index of not more than about 55, or a glycemic load of not more than about 6, or both;

b) at least about 5 g of amino acid source;

c) not more than about 3 g of digestible fat; and

d) a carbohydrate that provides at least about 2.5 g of dietary fiber.

### DETAILED DESCRIPTION OF THE INVENTION

I. Definitions

As used herein, the term “active level”, as it relates to the amount of desired material in an ingredient, refers to the level of the desired material in the ingredient, as measured by the methods for quantifying components of Applicant's invention, as detailed in the present application. For example, for fiber containing ingredients, the active level would be the actual percent fiber in the ingredient, as measured by the method for quantifying fiber as detailed in the present application.

As used herein, the term “an amino acid source” means a material containing amino acids. Said amino acid source may include or be derived from, but is not limited to, plant proteins, animal proteins, proteins from single cell organisms and free amino acids.

As used herein, the term “carbohydrate” refers to the total amount of sugar alcohols, monosaccharides, disaccharides, oligosaccharides, digestible, partially digestible and non-digestible polysaccharides; and lignin or lignin like materials that are present in the embodiments of the present invention.

As used herein, the term “dietary fiber” refers to the group of food components derived from plant material, or analogous carbohydrates, that are resistant to digestion and absorption in the human small intestine. This includes various polysaccharides, oligosaccharides, polyfructans, and lignins that are resistant to digestion. The term analogous carbohydrates in the above definition refers to carbohydrate compounds that may not be specifically derived from plant material, however, are resistant to digestion and absorption in the human small intestine (e.g., a synthetic non-digestible polysaccharide or oligosaccharide, such as polydextrose). As used herein, the terms “total dietary fiber” and “dietary fiber” are synonymous.

As used herein, the term “fat” refers to the total amount of digestible, partially digestible and nondigestible fats or oils that are present in the embodiments of the present invention. The terms “lipid”, “fat” and “oil” are used synonymously.

As used herein, the term “glycemic load” refers to the impact of a snack food on blood glucose. Glycemic load refers to the glycemic index of a food relative to its carbohydrate load. Thus, glycemic load is calculated as follows:

$$\frac{( Glycemic Index ) \times ( Available Carbohydrates )}{100}$$

Available carbohydrates are determined by subtracting the dietary fiber from the total carbohydrates. The glycemic load provides a better indication for how a serving of food impacts the body's blood sugar than does the glycemic index. For example, carrots have a high glycemic index of 92, but contain only 4.2 g of available carbohydrates to give a glycemic load of 3.9 for an 80 g serving. Brownies can have a lower glycemic index of 43, but have 34.6 g of available carbohydrates to give a glycemic load of 14.9 for a 56 g serving.

As used herein, the term “nutritionally balanced,” when used to describe a food, means that a single serving or reference serving of the food provides a nutritionally desirable level of fat, protein or amino acid source, and dietary fiber.

As used herein, the term “ready-to-eat” when used to describe a food, means that after manufacture and packaging, the food product requires no additional processing, including but not limited to cooking, baking, microwaving, boiling, frying; or combination with components outside of the product's packaging to achieve the novel combination of balanced nutrition and product form that Applicant is claiming. However, this does not rule out that one or all of the parameters of Applicant's nutritious traditional snack compositions may be improved when said compositions are processed further or combined with other foods.

As used herein, the term “predominately anhydrous” means having a water activity of less than about 0.6.

As used herein, the term “substantially anhydrous” means having a water activity of less than about 0.3.

As used herein, the term “traditional snack” means: 1) baked goods selected from the group consisting of cookies, brownies, filled crackers, snack cakes, pies, granola bars, and toaster pastries; 2) salted snacks selected from the group consisting of potato crisps, corn chips, tortilla chips, filled extruded snacks, enrobed extruded snacks and pretzels; 3) specialty snacks selected from the group consisting of dips, spreads, meat snacks and rice/corn cakes; and 4) confectionary snacks. For purposes of this invention, cereals are not considered to be a traditional snack, as they are normally considered and consumed as a main meal or breakfast food.

As used herein, the articles a and an when used in a claim, for example, “an amino acid source” or “a fat” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

II. Formulation & Nutritional Components

As is discussed in U.S. patent Publication Nos. 2002/0015760A1, 2002/0034574A1, 2002/0094359A1, 2002/0015761A1, 2002/0012722A1, 2002/0015759A1 and 2002/0012733A1, the key formulation obstacle associated with producing nutritionally balanced snack foods and mixes is achieving fat reduction, while at the same time incorporating sufficient amounts of protein and dietary fiber to achieve a balanced nutritional profile. Traditional snack foods typically contain 30-50% fat. The high fat levels may result from the product's formulation or may be introduced in a frying or seasoning process. Thus, for snacks, such as salted snacks, reducing the fat level to the recommended 3 g per serving requires either a change in formulation or processing. The standard industry “fix” to the fat reduction problem is to bake rather than fry snacks. While baked snacks, such as potato chips or corn chips, have reduced fat contents they tend to be less palatable as they are very dry, and have poor mouth melts and flavor displays. Even traditional baked snacks such as crackers, filled crackers, and cookies may contain high levels of fat (20-30%). In most cases, fat is intentionally added to the dough during formulation to enhance processability or taste, indirectly added as inherent fat or is topically sprayed on after baking. Unfortunately, with baked snacks there are no known process alternatives to baking.

A further challenge, not addressed in those publications, is to minimize the impact of the snack food on blood sugar. Typical snacks have glycemic index values in excess of 55, with some over 100. Natural snacks such a fruits may have low glycemic indexes, but are not nutritionally balanced. The following comparison in Table I illustrates these differences:

TABLE I

| | | Available | |
|---|---|---|---|
| | | Carbohydrates | |
| Food | Glycemic Index | per 30 g Serving | Glycemic Load |
| Pretzels | 116 | 23.1 | 26.8 |
| Potato Chips | 77 | 14.7 | 10.3 |
| Granola Bar | 59 | 25.9 | 11.2 |
| Soda Cracker | 74 | 21.4 | 15.8 |
| Apple | 56 | 3.7 | 2.1 |

The present invention fills the need for a snack food that, in addition to being organoleptically pleasing, is both nutritious and provides a relatively low glycemic index, and low glycemic load.

The following sections describe in detail the various nutritional components (amino acid, fat, carbohydrate and fiber), as well as the glycemic index and glycemic load, of the snacks of the present invention. Throughout the disclosure, Applicant uses alternate reference points in describing the snacks. Specifically, the snack foods are described on a 100 kcal basis and on a weight (e.g. 30 g) basis. It will be understood that these are independent reference points that may, but don't necessarily, overlap for the various individual embodiments of the present invention.

a. Amino Acid Component

An amino acid source is necessary to build and maintain muscle, blood, skin, and other tissues and organs, as well as for the formation of protein antibodies that are part of the immune system. The FDA has specified the Daily Reference Value for protein as 50 g/day (based upon a 2,000 kcal/day diet) and foods that provide at least 5 g protein per serving may be claimed as a “good source” of protein. Since athletes have higher protein requirements than sedentary individuals, the protein recommendations for athletes are approximately 1.5-2.0 times the Recommended Daily Allowance (RDA). See: Lemon, P. (1998) Effects of exercise on dietary protein requirements, International Journal of Sport Nutrition, 8:426-447. Due to the high levels of protein that athletes require and the off-flavors of protein supplements, a ready-to-eat, tasty, nutritionally balanced protein source is especially desired by these individuals.

Although increasing a food's protein level can increase the health benefits of the food, increased protein levels detract from a food's taste and texture. For example, highly concentrated protein sources in crumb structures can increase structural formation resulting in excessive hardness. In general, harder structures are more difficult to break down than softer structures, which results in negative mouth melt and flavor display properties during mastication. Also, some protein sources can influence dough-handling properties such as stickiness, which can impede processing the food form. Some nutritional protein sources effect water absorption and can effect dough properties and baking/frying properties.

In addition to the dough formulation and processing teachings detailed herein, some nutritional protein sources produce more noticeable off-flavors when used in fillings. For example, whey protein isolate has much less impact on flavor quality in a cheese filling than a similar amount of soy isolate protein. Also, the impact on flavor quality does not seem as apparent when these protein sources are used in a crumb structure. While not being bound by theory, it is thought that off-flavors imparted by ingredients are more noticeable in a lubricious fluid filling than in a baked solid or semi-solid crumb structure. In summary, care should be taken to either select protein sources that do not negatively affect flavor quality of the filling, or to include the protein source in the crumb formulation.

Amino acid sources that can be used to produce the nutritional compositions of the present invention may include or be derived from, but are not limited to, plant proteins, animal proteins, proteins from single cell organisms, free amino acids and mixtures thereof. Non-limiting examples of useful plant derived proteins include: seed proteins that are isolated or derived from legumes, such as soybeans, peanuts, peas and beans; cereal proteins isolated or derived from cereal grains, such as wheat, oats, rice, corn, barley and rye; and mixtures thereof. Non-limiting examples of useful seed proteins include materials selected from the group consisting of soy flour, soy protein concentrate, soy protein isolate, peanut flour and mixtures thereof. Non-limiting examples of useful cereal proteins include materials selected from the group consisting of wheat flour, wheat protein concentrate and mixtures thereof.

Non-limiting examples of useful animal-derived proteins include, milk proteins that are isolated or derived from bovine milk; muscle tissue proteins that are isolated or derived from mammals, reptiles or amphibians; connective tissue proteins, egg proteins isolated or derived from eggs or components of eggs; and mixtures thereof. Non-limiting examples of useful milk proteins include caseins, such as sodium caseinate and calcium caseinate; and whey proteins, such as beta-lactoglobulin and alpha-lactalbumin. These milk proteins may be derived from whole milk, skim milk, nonfat dry milk solids, whey, whey protein concentrate, whey protein isolate, caseinates, and mixtures thereof. Non-limiting examples of useful connective tissue proteins include collagen, gelatin, elastin and mixtures thereof.

Additional useful proteins include proteins that are isolated or derived from single cell microorganisms, including but not limited to, yeast, bacteria, algae and mixtures thereof, and free amino acids, in particular essential amino acids that can be added to enhance overall protein quality.

On a 30-gram basis, certain embodiments of the invention contain at least about 5 g of one or more amino acid sources. In other embodiments, each embodiment contains from about 5 g to about 10 g of one or more amino acid sources. In still other embodiments, each embodiment contains from about 5 g to about 7 g of one or more amino acid sources per 30 g of embodiment. In still other embodiments, each embodiment contains from about 5 g to about 6 g of one or more amino acid sources per 30 g of embodiment.

On a 100 kcal reference serving basis, certain embodiments of Applicant's invention contain at least 5 g of one or more amino acid sources per 100 kcal reference serving. In other embodiments of Applicant's invention, each embodiment contains from 5 g to 13 g of one or more amino acid sources per 100 kcal reference serving. In still other embodiments of Applicant's invention, each embodiment contains from 5 g to 8 g of one or more amino acid sources per 100 kcal reference serving. In still other embodiments of Applicant's invention, each embodiment contains from 5 g to 7 g of one or more amino acid sources per 100 kcal reference serving.

Preferred amino acid sources are proteins having active levels of at least 75% and minimal taste impacts on the final food product. Examples of preferred proteins include: soy protein isolates such as Supro® 661 which has an 85% active level and which is supplied by Protein Technologies of St. Louis, Mo. USA; whey protein isolates such as BiPRO which has an 95% active level and which is supplied by Davisco Foods Int. Inc. of Le Sueur, Minn. USA and egg whites such as Type P-110 (#407) which has an 80% active level and which is supplied by Henningsen Foods, Inc. of Rye Brook, N.Y. USA.

Although not required, certain embodiments of the invention have an amino acid chemical score greater than 0. In other embodiments of the invention, the amino acid chemical score ranges from 0.6 to 1.0 and in still other embodiments the amino acid chemical score ranges from 0.75 to 1.0. In still other embodiments of the invention the amino acid chemical score ranges from 0.85 to 1.0. Amino acid sources rich in specific amino acids are particularly useful as they can provide the additional benefit of increasing the overall protein quality or amino acid chemical score of a food composition. For example, because peanut protein contains a low lysine level, embodiments of the invention containing a peanut butter filling may be fortified with an additional amino acid source rich in lysine, such as whey protein, which results in a product having an amino acid score of 1.0.

b. Fat Component

The American diet currently averages approximately 34% of total caloric intake from fat and approximately 12% of calories from saturated fat (Garrison, R. and Somer, E., The Nutrition Desk Reference, 3rd edition, 1995, Keats Publishing, New Cannan, Conn.). The level of dietary fat intake, particularly saturated fat and cholesterol, is strongly linked to the risk of cardiovascular disease and mortality from coronary events. In addition, research has demonstrated a relationship between the level of total fat and saturated fat consumption and the risk of cancers of the digestive tract and endocrine system (e.g., colorectal, breast, and prostate cancers) (Garrison and Somer, 1995).

Based on the relationship between fat intake and the chronic diseases mentioned above, various professional health organizations (e.g. American Heart Association; American Cancer Society; National Cancer Institute; United States Department of Agriculture) have proposed dietary guidelines stating that the percent of total caloric intake from fat be reduced to less than 30% and the percent of calories from saturated fat decreased to less than 10%.

On a 30-gram basis, certain embodiments of Applicant's invention contain not more than about 3 g of one or more digestible fats. In other embodiments of Applicant's invention, each embodiment contains not more than about 2 g of one or more digestible fats per 30 g of embodiment. In still other embodiments of Applicant's invention, each embodiment contains not more than about 1 g of one or more digestible fats per 30 g of embodiment. In still other embodiments of Applicant's invention, each embodiment contains from about 0.01 g to about 3 g of one or more digestible fats per 30 g of embodiment.

On a 30-gram basis, certain embodiments of Applicant's invention contain not more than about 2 g of one or more digestible saturated fats. In other embodiments of Applicant's invention, each embodiment contains not more than about ⅔ of a gram of one or more digestible saturated fats per 30 g of embodiment. In still other embodiments of Applicant's invention, each embodiment contains not more than about ⅓ of a gram of one or more digestible saturated fats per 30 g of embodiment. In still other embodiments of Applicant's invention, each embodiment contains from about 0.01 g to about 1 g of one or more digestible saturated fats per 30 g of embodiment.

On a 100 kcal reference serving basis, certain embodiments of Applicant's invention contain not more than about 3 g of one or more digestible fats per 100 kcal reference serving of said embodiment. In other embodiments of Applicant's invention, each embodiment contains not more than about 2 g of one or more digestible fats per 100 kcal reference serving of said embodiment. In still other embodiments of Applicant's invention, each embodiment contains not more than about 1 g of one or more digestible fats per 100 kcal reference serving of said embodiment. In still other embodiments of Applicant's invention, each embodiment contains from about 0.01 g to about 3 g of one or more digestible fats per 100 kcal reference serving of said embodiment.

On a 100 kcal reference serving basis, additional embodiments of Applicant's invention contain not more than about 2 g of one or more digestible saturated fats per 100 kcal reference serving of said embodiment. In other embodiments of Applicant's invention, each embodiment contains not more than about ⅔ of a gram of one or more digestible saturated fats per 100 kcal reference serving of said embodiment. In still other embodiments of Applicant's invention, each embodiment contains not more than about ⅓ of a gram of one or more digestible saturated fats per 100 kcal reference serving of said embodiment. In still other embodiments of Applicant's invention, each embodiment contains from about 0.01 g to about 1 g of digestible saturated fat per 100 kcal reference serving of said embodiment.

In order to meet the low-fat requirements for a balanced nutritional profile, the digestible fat levels of most foods must be reduced significantly. However, a low level of fat in a crumb structure results in a very dry product during mastication. Also, in an anhydrous (oil continuous) filling, low fat formulations result in very dry, stiff fillings, with poor mouth melt. When the digestible fat level of a product is reduced, the product's texture and taste can be improved by replacing the digestible fat with non-digestible lipids, partially digestible lipids or mixtures thereof on a weight percent to weight percent basis. When the use of non-digestible lipids, partially digestible lipids or mixtures thereof is precluded by regulatory or processing concerns, water continuous fillings, such as fruit fillings having water activities of less than 0.80 may be used to enhance lubricity and thus the texture and taste of the product. For example, the taste system of a filled bar, wherein the crumb contains less than 3 g of triglyceride fat per serving, is improved by selecting a water continuous filling. When a non-perishable product is desired, it is preferred that the filling's water activity be sufficiently low to prevent the growth of most pathogenic and spoilage bacteria.

When water based fillings cannot be used, and the product is substantially anhydrous, the product's taste may be substantially improved by a continuous phase that comprises a glassy structure below its transition point. It is preferred that the glassy structure comprise sugars, polysaccharides and mixtures thereof, rather than starches that have a fast mouth melt. For example, a snack crisp structure is formed by a non-traditional composition that is low in fat, and high in protein and dietary fiber. The snack crisp contains none of the traditional structure forming components such as flour or starches. It is based on a continuous phase of an amorphous glass that is interrupted by particles of dietary fiber and protein isolates. These normally unpalatable ingredients are enclosed within an amorphous glass structure having a crispy-crunchy texture and a quick mouth melt. The amorphous glass may be formed by a variety of sugars or maltodextrin combinations. The resulting forms range from very sweet to savory. Flavors and “bits” may be added topically, or be contained within the structure. The snack crisp structure may be attained by baking, or by extrusion, followed by a baking or drying step. The snack crisp provides a tasty, nutritionally balanced food that is capable of contributing high levels of dietary fiber and protein to a diet.

Fats that can be used to produce the nutritional compositions of the present invention may include or be derived from, but are not limited to, vegetable oils and fats, lauric oils and fats, milk fat, animal fats, marine oils, partially-digestible and nondigestible oils and fats, surface-active lipids and mixtures thereof. Useful vegetable oils and fats include, but are not limited to, triacylglycerols based on C₁₈ unsaturated fatty acids such as oleic acids, linoleic acids, linolenic acids and mixtures thereof. Non-limiting examples of useful unhydrogenated, partially-hydrogenated and fully-hydrogenated vegetable oils include oils derived or isolated from soybeans, safflowers, olives, corn, cottonseeds, palm, peanuts, flaxseeds, sunflowers, rice bran, sesame, rapeseed, cocoa butter and mixtures thereof.

Useful lauric oils and fats include, but are not limited to, triacylglycerols based on lauric acid having 12 carbons. Non-limiting examples of useful lauric oils and fats include coconut oil, palm kernel oil, babassu oil and mixtures thereof.

Useful animal fats include, but not are not limited to, lard, beef tallow, egg lipids, intrinsic fat in muscle tissue and mixtures thereof.

Useful marine oils include, but are not limited to, triacylglycerols based on omega-3 polyunsaturated fatty acids such as docosahexanoic acid C22:6. Non-limiting examples of useful marine oils include menhaden oil, herring oil and mixtures thereof.

Useful partially-digestible and non-digestible oils and fats include, but are not limited to, polyol fatty acid polyesters, structured triglycerides, plant sterols and sterol esters, other non-digestible lipids such as esterified propoxylated glycerin (EPG), and mixtures thereof. Useful polyol fatty acid polyesters include, but are not limited to, sucrose polyesters, which are sold under the trade name of Olean™ by the Procter & Gamble Company of Cincinnati, Ohio U.S.A. Non-limiting examples of useful structured triglycerides include caprenin, salatrim and mixtures thereof. Non-limiting examples of useful plant sterols and sterol esters include sitosterol, sitostanol, campesterol and mixtures thereof.

The preferred nondigestible lipid is Olean™, which is sold by the Procter & Gamble Company of Cincinnati, Ohio U.S.A. Preferred partially digestible lipids are structured triglycerides comprising a combination of fluid chain fatty acids (i.e., short-chain saturated or unsaturated fatty acids) with long-chain, saturated fatty acids (chain lengths of C18-C24). An example of a partially digestible lipid is caprenin (Procter & Gamble Company, Cincinnati, Ohio, U.S.A.), which is a structured triglyceride comprised of octanoic acid (C8:0), decanoic acid (C10:0), and behenic acid (C22:0). Other examples are the reduced calorie triglycerides described in U.S. Pat. No. 5,419,925 (Seiden et al., assigned to The Procter & Gamble Company, Cincinnati, Ohio, U.S.A.), which are triglycerides comprised of short chain-length, saturated fatty acids (C6:0-C10:0) and long chain-length, saturated fatty acids (C18:0-C24:0). Another example of partially digestible lipids are the salatrim family of low calorie fats developed by the Nabisco Foods Group (East Hanover, N.J.). The salatrim low-calorie fats are triglycerides comprised of short chain fatty acid residues (C2:0-C4:0) and long chain, saturated fatty acids (C16:0-C22:0); see Smith et al., “Overview of Salatrim, a Family of Low-Calorie Fats”, J. Agric. Food Chem., 42:432-434, (1994); and Softly et al., “Composition of Representative Salatrim Fat Preparations”, J. Agric. Food Chem., 42:461-467, (1994). Salatrim is available under the brand name, Benefat™, from Cultor Food Science (Ardsley, N.Y.). Benefat™ is a specific component of the salatrim family, comprising acetic (C2:0), proprionic (C3:0), butyric (C4:0), and stearic (C18:0) acids.

c. Carbohydrate Component

As used herein, the term “carbohydrate” refers to the total amount of sugar alcohols, monosaccharides, disaccharides, oligosaccharides, digestible, partially digestible and non-digestible polysaccharides; and lignin or lignin like materials that are present in the embodiments of the present invention.

Carbohydrates that can be incorporated into the present invention may include, but are not limited to, monosaccharides, disaccharides, oligosaccharides, polysaccharides, sugar alcohols and mixtures thereof. Non-limiting examples of useful monosaccharides include: tetroses such as erythrose; pentoses such as arabinose, xylose, and ribose; and hexoses such as glucose (dextrose), fructose, galactose, mannose, sorbose and tagatose.

Non-limiting examples of useful disaccharides include: sucrose, maltose, lactose and cellobiose.

Non-limiting examples of useful oligosaccharides include: fructooligosaccharide; maltotriose; raffinose; stachyose; and corn syrup solids (maltose oligomers with n=4-10).

Useful polysaccharides include, but are not limited to, digestible polysaccharides and non-digestible polysaccharides. Non-limiting examples of useful digestible polysaccharides include starches that are isolated or derived from cereal grains, legumes, tubers and roots; maltodextrins obtained by the partial hydrolysis of starch; glycogen and mixtures thereof. Non-limiting examples of useful starches include flours from cereals, legumes, tubers and roots; native, unmodified starches, pre-gelatinized starches, chemically modified starches, high amylose starches, waxy starches; and mixtures thereof.

Useful non-digestible polysaccharides may be water-soluble or water-insoluble. Non-limiting examples of useful water-soluble or predominately water-soluble, non-digestible polysaccharides include: oat bran; barley bran; psyllium; pentosans; plant extracts such as pectins, inulin, and beta-glucan soluble fiber; seed galactomannans such as guar gum, and locust bean gum; plant exudates such as gum arabic, gum tragacanth, and gum karaya; seaweed extracts such as agar, carrageenans, alginates, and furcellaran; cellulose derivatives such as carboxymethylcellulose, hydroxypropyl methylcellulose and methylcellulose; microbial gums such as xanthan gum and gellan gum; hemicellulose; polydextrose; and mixtures thereof. Non-limiting examples of water-insoluble, and predominately water-insoluble, non-digestible polysaccharides include cellulose, microcrystalline cellulose, brans, resistant starch, and mixtures thereof.

Useful sugar alcohols include, but are not limited to, glycerol, sorbitol, xylitol, mannitol, maltitol, propylene glycol, erythritol and mixtures thereof.

d. Fiber Component

Dietary fiber comprises the food components derived from plant material, or analogous carbohydrates, that are resistant to digestion and absorption in the human small intestine. This includes various polysaccharides, oligosaccharides, polyfructans, and lignins that are resistant to digestion. The term analogous carbohydrates refers to carbohydrate compounds that may not be specifically derived from plant material, but that are resistant to digestion and absorption in the human small intestine (e.g., a synthetic non-digestible polysaccharide or oligosaccharide, such as polydextrose). Many fiber constituents are carbohydrates, such as cellulose, hemicellulose, pectin, guar gum and beta-glucan soluble fiber. Lignin, a component of the woody structure of plants, is not considered a classical carbohydrate; however, it is non-digestible and is included in the measurement of total dietary fiber. Thus, for purposes of Applicant's invention, lignin and lignin like materials are classified as carbohydrates.

Dietary fibers may be further classified into water-soluble (e.g., pectin, guar, beta-glucan soluble fiber) and insoluble (e.g., cellulose) fractions. The current average intake of dietary fiber in the United States is approximately 10 g/day. Recommendations from health professionals are to increase consumption of fiber-rich foods in order to achieve a daily fiber intake of approximately 25-35 g (Garrison and Somer, 1995). The United States Food and Drug Administration (FDA) has specified the Daily Reference Value for dietary fiber for use on food labels as 25 g/day (based upon a 2,000 kcal/day diet) (Code of Federal Regulations; 21 CFR § 101.9). Foods that provide at least 2.5 g dietary fiber per serving may be claimed as a “good source” of fiber. A high fiber intake is believed to be beneficial for reducing the risk of cardiovascular diseases, colorectal cancer, constipation, diverticulosis, and other gastrointestinal disorders. For example, certain soluble fibers such as pectin, guar gum, psyllium, and beta-glucan soluble fiber have been shown to provide heart health benefits by reducing serum total and low-density lipoprotein (LDL) cholesterol (Brown, L. et al., Am J Clin Nutr, 1999, 69:30-42). While not being limited by theory, the mechanism for this effect is believed to be related to soluble fiber's impact on viscosity of the digesta in the small intestine; i.e., a significant increase in digesta viscosity reduces the reabsorption of bile acids. In addition, certain soluble fibers are partially or completely fermented by microorganisms in the large intestine, producing short-chain fatty acids (acetic, propionic, butyric acids) which are absorbed and may provide an inhibitory effect on cholesterol synthesis in the liver. Again, while not being limited by theory, high fiber diets, particularly those high in insoluble fiber, are believed to reduce the incidence of colon and rectal cancers by promoting an increased transit rate of potential carcinogens through the intestinal tract, diluting the concentration of carcinogenic agents through increased water retention in the stool, and possibly by binding toxic compounds and promoting their elimination.

Furthermore, choosing a diet that is moderate in sugar content was one of the recommendations in the most recent publication of Dietary Guidelines for Americans (U.S. Department of Agriculture, 4th edition, 1995). An individual can reduce their sugar intake by eating protein and dietary fiber enriched foods, as the percentage of carbohydrates, and possibly simple sugars, in these foods is reduced. Protein and fiber enriched foods may also benefit diabetics as they must carefully monitor their total carbohydrate intake. Thus, protein and fiber-enriched foods that are relatively low in total carbohydrate content may be a useful addition to their overall dietary plan. An elevated fiber content also benefits diabetics by helping manage blood glucose levels (glycemic control) and postprandial insulin levels (Anderson, J. W. and Akanji, A. O., 1993, in CRC Handbook of Dietary Fiber in Human Nutrition, 2nd edition, G. A. Spiller, ed., CRC Press).

In view of the health benefits associated with ingesting dietary fiber, certain embodiments of Applicant's invention, contain, on a 30-gram basis, at least about 2.5 g of dietary fiber. Other embodiments of Applicant's invention contain from about 2.5 g to about 5 g of dietary fiber per 30 g of embodiment, while still other embodiments of Applicant's invention contain from about 2.5 g to about 3.5 g of dietary fiber per 30 g of embodiment.

On a 100 kcal reference serving basis, certain embodiments of Applicant's invention, contain at least about 2.5 g of dietary fiber. Other embodiments of Applicant's invention contain from about 2.5 g to about 5 g of dietary fiber per 100 kcal reference serving, while still other embodiments of Applicant's invention contain about 2.5 g to about 3.5 g of dietary fiber per 100 kcal reference serving.

The dietary fiber used in Applicant's invention comprises from 0% to 100% by weight soluble dietary fiber and from 0% to 100% by weight insoluble dietary fiber. In certain embodiments of Applicant's invention, said dietary fiber comprises from 50% to 100% by weight soluble dietary fiber and from 0% to 50% by weight insoluble dietary fiber. In still other embodiments of Applicant's invention, said dietary fiber comprises from 70% to 100% by weight soluble dietary fiber and from 0% to 30% by weight insoluble dietary fiber.

Although dietary fiber is a critical component of a nutritionally balanced food, dietary fiber can have adverse effects on taste due to off-flavors that are inherent in fiber sources and the negative textural properties that dietary fiber sources can impart to foods. This is particularly true when fat is replaced with dietary fiber. The off-flavors that dietary fibers impart can be minimized by selecting fiber sources having high active levels—active levels of at least 75% are preferred. Also, for insoluble dietary fibers, key levers affecting taste are particle size and water absorption. Applicant has determined that, in order to avoid producing finished foods having gritty textures, insoluble dietary fibers having particle sizes of less than about 150 microns, and more preferably less than about 50 microns, are preferably used. In addition, in order to avoid dryness due to saliva absorption during mastication, it is preferred that the water absorption of insoluble dietary fibers be less than about 7 g water per g of fiber and most preferably less than about 3.5 g of water per g of fiber. Examples of insoluble dietary fibers having an active level of at least 75%, a particle size less than 150 microns (preferably less that 50 microns) and a water absorption of less than about 7 g water per g of fiber include: Vitacel® wheat fiber WF-600/30 from J. Rettenmaier & Sohne Gmbh+Co. of Ellwangen/J., Federal Republic of Germany and Centara III pea fiber which can be obtained from Parrheim Foods Portage La Prairie, Manitoba, Canada.

When soluble dietary fibers are in the presence of liquids like saliva, the key lever affecting taste is viscosity. Many dietary fibers have considerable thickening effects when combined with water/saliva. Thickened fillings or thickening that occurs during mastication can produce unpleasant textures, slow mouth melts, and slow the rate of flavor display. In order to avoid undesired thickening, a viscosity effect similar to that of sucrose is preferred. Thus, the viscosity at 25° C. should be less than about 1-2 centipoise (cp) for a 10% solution, and less than about 200 centipoise for a 50% solution. It is also preferable that the viscosity remain close to Newtonian. Soluble dietary fibers having an active level of at least 75% and a viscosity effect that is similar to sucrose include: maltodextrin dietary fibers such as Fibersol 2 which has an active level (total dietary fiber) of 85% and a viscosity of about 1.5 cp for a 10% solution and which can be obtained from Matsutani Chemical Industry C., Ltd. of Itam-city Hyogo, Japan; and arabinogalactan dietary fibers such as Fiberaid® which has an active level (total dietary fiber) of 85% and a viscosity of about 2 cp for a 10% solution and which can be obtained from Larex Inc. of White Bear Lake, Minn.

Oat bran dietary fiber, such as Oatcor Oat Bran Concentrate (The Quaker Oats Co. Chicago, Ill.) which is rich in beta-glucan soluble fiber (11.5%), is another preferred fiber, as it can provide a heart health/cholesterol lowering benefit when present at a level sufficient to provide 0.75 g beta-glucan soluble fiber per 40-gram serving level. The amount of oat bran dietary fiber needed to provide 0.75 g beta-glucan soluble fiber per 40-gram serving level can be determined by determining the amount of beta-glucan soluble fiber per mass unit of oat bran dietary fiber, using the beta-glucan soluble fiber analysis method found in Applicant's Analytical Protocols. Once the amount of beta-glucan soluble fiber per mass unit of oat bran dietary fiber is known, one skilled in the art can calculate how much oat bran dietary fiber to incorporate in a product to achieve the desired level of beta-glucan soluble fiber.

For soluble dietary fibers in predominately anhydrous foods, key levers affecting taste are particle size, water absorption, and dissolution rates. If the dissolution rate, which is analogous to the rate of hydration, is too slow, soluble fibers having particle sizes greater than 50 microns and most particularly from 50 to 200 microns, will impart a gritty, dry texture to foods—these undesirable textural characteristics are especially noticeable when the fiber is used at a level of more than about 1 g per serving, and most particularly noticeable above about 2.5 g per serving. Soluble fibers, especially when present with insoluble fibers or other surrounding matrixes, can swell upon hydration and absorb high amounts of water. During mastication, this effect increases the dryness impression and viscosity of the food and thus detracts from a food's flavor display. The resulting dryness impression and increase in viscosity is sensed as an unpleasant thick and often slimy texture that has a poor flavor display. Again, dryness and viscosity issues can be minimized, thus an overall taste improvement can be realized, by selecting soluble fibers that have a minimal viscosity effect, and a dissolution rate as similar as possible to the rate of sucrose. The rates of dissolution can be compared by observing the dissolution rate of 1 teaspoon soluble fiber in 250 mL of water at 25° C. versus 1 teaspoon sucrose in 250 mL of water at 25° C. The fiber and sugar are slowly added simultaneously to their respective aliquots of water with gentle stirring.

e. Glycemic Index & Glycemic Load

Typical snacks have glycemic index values in excess of 55, with some over 100, and glycemic loads in excess of 10, with some over 20. Natural foods typically used as snacks, such as fruits may have low glycemic indexes and/or low glycemic loads, but are not nutritionally balanced. Foods are considered to have a low glycemic index if the GI is <55. Foods may be considered to have a low glycemic load if the GL is <5.

The glycemic load of a food is a function of its glycemic index, and the amount of available carbohydrates. The glycemic index of a food is a function of carbohydrate, fat, protein and fiber composition. The type of carbohydrate and its degree of processing also impact the glycemic index. For example carbohydrates contained in white rice, potato and white breads are high GI, while the carbohydrates contained in fruit, and vegetables are generally low GI. Furthermore raw potatoes are low GI, while cooked potatoes are high GI, due to the chemical and physical changes to the starch. Likewise processed and refined grains, such as white flour, are high GI, while whole grains, such as whole wheat, are lower GI.

Certain embodiments of Applicant's invention will have a glycemic index of not more than about 55. Other embodiments of Applicant's invention will have a glycemic index of not more than about 40, while still other embodiments will have a glycemic index of not more than about 30. The embodiments of Applicant's invention will generally have a glycemic index of from about 20 to about 55.

Although glycemic index and available carbohydrates are independent characteristics of the improved snack foods of the present invention, certain embodiments will have a glycemic load of not more than about 6 on a 30 g reference basis. Other embodiments on a 30 g basis will have a glycemic load of not more than about 4, preferably not more than about 2.

For a given glycemic index, the glycemic load of a food may be controlled by the carbohydrate level. Substituting dietary fiber, and/or protein for carbohydrate in the food will lower the level of available carbohydrates.

f. Water Activity

The present compositions have water activities that are less than or equal to about 0.90. Other embodiments of Applicant's invention are “non-perishable”, thus they have water activities that are sufficiently low to prevent the growth of most pathogenic and spoilage bacteria; i.e., a water activity less than about 0.85 (Troller, J. A. 1980, Influence of Water Activity on Microorganisms in Foods, Food Technology, 34:76-80; Troller, J. A. 1989, Water Activity and Food Quality, in “Water and Food Quality”, T. M. Hardman, ed., pg. 1-31). Preferably, embodiments of Applicant's invention have water activities low enough to control or prevent the growth of yeasts and molds; i.e., a water activity not more than about 0.80, more preferably not more than about 0.75, and most preferably not more than about 0.70.

g. Adjunct Ingredients

Adjunct ingredients are necessary for processing and structural development of most foods. Examples of typical adjunct ingredients include processing aids, emulsifiers, and leavening agents. As known by those skilled in the art, the required adjunct ingredients that are needed to produce foods vary by food type. Selection of the appropriate type and level of adjunct is easily determined by one skilled in the art as said information is available in reference sources. For example, it is well known that crackers rely heavily on processing aids and leavening agents. Leavening agents provide the internal expansion or rise of the product during baking. Crackers without leavening would be thin and dense and would have an unpleasant eating quality. Processing aids such as reductants and enzymes are required either singularly or in combination to allow adequate machining (i.e., dough sheeting and die cutting), and/or development of necessary structure. They are believed to function by breaking bonds in the gluten complex of the dough (i.e., disulfide cross-linkages and peptide bonds).

In addition, it is known by those skilled in the art that extruded snacks utilize emulsifiers, and may use leavening agents. The role of the emulsifier is to aid in processing (for example sheeting dough) and the formation of the internal product structure.

It is also known that cookies rely heavily on the use of leavening agents and emulsifiers. Other baked goods such as brownies, muffins, snack cakes, and pastries also rely on leavening agents and emulsifiers to achieve their desired structure. Snack cakes are at the high end of functionality, as they require the most care in the choice and blends of leavening agents and emulsifiers to achieve their tender highly cellular structure. Brownies are generally at the lower end of functionality, as they typically have a more dense structure.

Finally, it is known that fillings generally require the use of an emulsifier or whipping agent to aid in processing, texture formation, and mouth melt. For example, peanut butter based fillings may utilize an emulsifier to aid in particle dispersion during processing. Emulsifiers are also used in confectionery fillings to aid in the creation of textures and improve mouth melt. For example, chocolate uses an emulsifier to reduce the level of cocoa butter fat required in its final composition. Some fillings (nugat) utilize whipping agents to incorporate air into the filling in order to attain a desired texture and mouth melt.

Although the type and level of adjunct ingredients that are needed to produce any specific food product is known by those skilled in the art, Applicant has provided a number of examples wherein the type and level of adjunct ingredients used to produce a variety of foods is listed.

h. Additional Ingredients

Additional ingredients that may be incorporated in Applicant's invention include natural and synthetically prepared flavoring agents, non-caloric sweeteners, bracers, flavanols, natural and synthetically prepared colors, preservatives, acidulants, and food stability anti-oxidants. A discussion of flavoring agents useful in the present foods is described in co-pending U.S. patent Publication No. 2002/0015759A1.

Embodiments of the present invention may optionally be fortified with vitamins and minerals. The U.S. Recommended Dietary Allowances (U.S. RDA) are a set of nutrient standards established by the Food and Nutrition Board of the National Academy of Sciences (Food and Nutrition Board, 1989, Recommended Dietary Allowances, 10 ed., National Research Council, National Academy of Sciences, Washington, D.C.). The RDA's for vitamins and minerals represent the average daily intake considered adequate to meet the nutritional needs of most healthy individuals in the United States. The RDA for a particular vitamin or mineral varies depending on age, gender, and physiological state (e.g., pregnant, lactating). The Reference Daily Intakes (RDI) for vitamins and minerals were established by the Food and Drug Administration to reflect the average nutrient allowances for adults and are used for nutrition labeling on food products in the United States. A discussion of vitamins useful in the present invention, and the relevant amounts that can be incorporated, is described in co-pending U.S. patent Publication No. 2002/0015759A1.

Embodiments of the present invention may be fortified with minerals such as calcium, phosphorus, magnesium, iron, zinc, iodine, selenium, copper, manganese, fluoride, chromium, molybdenum, sodium, potassium, and chloride. The minerals sources are preferably present in nutritionally relevant amounts, which means that the mineral sources used in the practice of this invention provide a nourishing amount of said minerals. Preferably, this amount comprises at least about 1% of the U.S. RDA or RDI for these minerals, more preferably from about 1% to about 100%, and most preferably from about 10% to about 100% of the U.S. RDA or RDI per 30 g reference serving of the finished product. Of course, it is recognized that the preferred daily intake of any mineral may vary with the user, with greater than the U.S. RDA or RDI intakes being beneficial in some circumstances. A discussion of minerals useful in the present invention, and the relevant amounts that can be incorporated, is set forth in co-pending U.S. patent Publication No. 2002/0015759A1.

If desired, coloring agents can also be added to the food compositions of the present invention. Any soluble coloring agents approved for food use can be utilized for the present invention.

When desired, preservatives, such as sorbic acid, benzoic acid, hexametaphosphate and salts thereof, can be added into embodiments of the present invention.

Also, if desired, the composition can contain an acidulant including but not limited to malic, citric, tartaric, and fumaric acids and mixtures thereof.

Organic as well as inorganic edible acids may be used to adjust the pH of Applicant's foods. The preferred acids are edible organic acids that include citric acid, malic acid, fumaric acid, adipic acid, phosphoric acid, gluconic acid, tartaric acid, ascorbic acid.

h. Structural Parameters

A food's flavor display and texture, and thus its taste, are dependent on the food's composition and structural parameters. As a result, structural parameters are important to realizing the combination of good taste and healthy profile. The teachings of U.S. patent Publication No. 2002/0015759A1 concerning crumb and filling structural parameters are applicable to the snack foods of the present invention. Similarly, the teachings of that published application concerning cracker and filling making, as set forth in the Process of Making Nutritious Compositions section, are applicable to the snack foods of the present invention.

These examples are illustrative of the invention and are not to be construed to limit the invention in any way.

### EXAMPLE 1

### Snack Bar Product

Part I. Binder Formulation

| Ingredient | Percentage |
|---|---|
| Fructose Syrup @ 77% TDS* | 59.1 |
| Sugar | 23.5 |
| Fiberaid (Larch Fiber) | 17.4 |
| Added Water to adjust to 82 TDS | |

*TDS = TOTAL DISOLVED SOLIDS

Part II. Bar Formulation

| Ingredient | Percentage |
|---|---|
| Soy Krispie Exp HO309 (Solae) | 18.2 |
| Crisp Rice 217 (Pacific Grain) | 4.6 |
| Rolled Barley (General Mills) | 9.2 |
| Barley Crisps (Pacific Grain) | 4.6 |
| Guar Gum NT Brand | .4 |
| Almonds | 7 |
| Diced Strawberry Flavored Fruit | 5.9 |
| Blueberries | 5.9 |
| Dried Red Sour Cherries | 5.9 |
| Peanut Butter | 8.7 |
| Lecithin | .02 |
| Syrup Binder from above | 29.1 |
| Salt | .06 |
| Vanilla | .4 |
| Mixed Berry Flavor | .02 |

### Method of Making

### EXAMPLE 1

The binder from Part I. is made by heating the fructose syrup to about 150° F. (66° C.). The sugar is added next and stirred until completely dissolved. Next the Fiberaid is added and stirred until completely dissolved. The total dissolved solids (TDS) is measured using a refractometer. Water is then added to adjust the TDS to 82%. The peanut butter and lecithin are combined and heated to about 150° F. (66° C.).

The bar is then mixed according to the Bar Formulation (Part II.) by first combining the dry ingredients in a low shear mixer. The flavor and salt are then added to the binder. The binder and peanut butter are then added to the dry ingredients and gently mixed together. Mixing may be by hand, or on a larger scale in a double arm mixer, or a ribbon mixer or similar low shear mixing equipment.

The bars are then made by pouring the mixed ingredients out of the mixer and rolling them by hand or by mechanical rollers into a slab about ⅜ in. (0.95 cm) to 1.25 in. (3.175 cm) thick. The slab is then cooled to about 70° F. (21° C.) or below, and next cut into bars, or other desired shapes.

The nutritional profile of the above formulation is about 2.9 g fat, 6.6 g protein, and 3.4 g dietary fiber. The fat would be about 23% of the calories, and the protein would compose about 23.4% of the calories. The glycemic index would be expected to be about 32, with an expected glycemic load of about 5 for a 30 g serving.

### EXAMPLE 2

### Snack Bar Product

Part I. Binder Formulation

| Ingredient | Percentage |
|---|---|
| Fructose Syrup @ 77% TDS* | 50 |
| Fiberaid ™ (Larch Fiber) | 50 |
| Added Water to adjust to 82 TDS | |

*TDS = TOTAL DISOLVED SOLIDS

Part II. Bar Formulation

| Ingredient | Percentage |
|---|---|
| Soy Krispies Exp HO309 (SOLAE) | 22.4 |
| Rolled Barley (General Mills) | 9.2 |
| Barley Crisps (Pacific Grain) | 4.6 |
| Guar Gum NT Brand | 1.0 |
| Almonds | 6 |
| Dried Red Sour Cherries | 17.5 |
| Peanut Butter | 8.7 |
| Lecithin | .02 |
| Syrup Binder from above | 30.1 |
| Salt | .06 |
| Vanilla | .4 |
| Mixed Berry Flavor | .02 |

### Method of Making

### EXAMPLE 2

The binder from Part I. is made by heating the fructose syrup to about 150° F. (66° C.). The Fiberaid is then added and stirred until completely dissolved. The total dissolved solids (TDS) is measured using a refractometer. Water is then added to adjust the TDS to 82%. The peanut butter and lecithin are combined and heated to about 150° F. (66° C.).

The bar is then mixed according to the Bar Formulation (Part II) by first combining the dry ingredients in a low shear mixer. The flavor and salt are then added to the binder. The binder and peanut butter are then added to the dry ingredients and gently mixed together. Mixing may be by hand, or on a larger scale in a double arm mixer, or a ribbon mixer or similar low shear mixing equipment.

The bars are then made by pouring the mixed ingredients out of the mixer and rolling them by hand or by mechanical rollers into a slab about ⅜ in. (0.95 cm) to 1.25 in. (3.175 cm) thick. The slab is then cooled to about 70° F. (21° C.) or below, and next cut into bars, or other desired shapes.

The nutritional profile of the above formulation is about 2.8 g fat, 7.9 g protein, and 5.9 g dietary fiber. The fat would be about 25% of the calories, and the protein would compose about 30.6% of the calories. The glycemic index would be expected to be about 22, with an expected glycemic load of about 2.5 for a 30 g serving.

### EXAMPLE 3

### Sandwiched Snack Bar Product

Part I. Binder Formulation

| Ingredient | Percentage |
|---|---|
| Fructose Syrup @ 77% TDS* | 59.1 |
| Sugar | 23.5 |
| Fiberaid ™ (Larch Fiber) | 17.4 |
| Added Water to adjust to 82 TDS | |

*TDS = TOTAL DISOLVED SOLIDS

Part II. Bar Formulation

| Ingredient | Percentage |
|---|---|
| Soy Krispies Exp HO309 (SOLAE) | 18 |
| Barley Crisps (Pacific Grain) | 22.3 |
| Cheese Powder (Kraft Cheezing) | 10 |
| Cilantro Oil | 1.3 |
| Peanut Butter | 4 |
| Lecithing | .02 |
| Syrup Binder from above | 40.5 |
| Salt | .25 |
| Parsley Flakes | .2 |
| Ground Cummin | .5 |
| Chile Powder (Ancho) | .75 |
| Dried Minced Onions | 2.1 |
| Salt n' Vinegar Flavor (Kerry) | .08 |

Part III. Filling Formulation

| Ingredient | Percentage |
|---|---|
| Crisco Shortening | .32 |
| Kaomel Flakes | 4.68 |
| Powdered Sugar | 28.08 |
| Fiberaid ™ | 12.48 |
| Sweet Cream Powder | 4.68 |
| Olean | 29.64 |
| Cream Cheese Powder (Kraft) | 17.78 |
| Vanilla Powder | 2.34 |

### Method of Making

### EXAMPLE 3

The binder from Part I. is made by heating the fructose syrup to about 150° F. (66° C.). Sugar is added and stirred until completely dissolved. The Fiberaid™ is then added and stirred until completely dissolved. The total dissolved solids (TDS) is measured using a refractometer. Water is then added to adjust the TDS to 82%. The peanut butter and lecithin are combined and heated to about 150° F. (66° C.).

The bar is then mixed according to the Bar Formulation (Part II.) by first combining the dry ingredients in a low shear mixer. The flavor and salt are then added to the binder. The binder and peanut butter are then added to the dry ingredients and gently mixed together. Mixing may be by hand, or on a larger scale in a double arm mixer, or a ribbon mixer or similar low shear mixing equipment.

The filling is then prepared according to the formulation in Part III. The shortening, Crisco®, Kaomel flakes and Olean® are combined and heated to above 120° F. (49° C.). The dry ingredients are then added and the total batch mixed together.

The bars are then made by pouring the mixed ingredients out of the mixer and rolling them by hand or by mechanical rollers into a slab about ⅛ in. (0.32 cm) to ⅜ (0.95 cm) thick. The filling is then deposited on top of the slab, and a second portion of the slab is placed on top. The ration of bar to filling is 75/25. This sandwich type construction is then pressed together with enough compressive force to hold the two layers and filling together. The sandwiched slab is then cooled to about 70° F. (21° C.) or below, and next cut into bars, or other desired shapes.

The nutritional profile of the above formulation is about 2.9 g fat, 5.5 g protein, and 3.2 g dietary fiber. The fat would be about 26.4% of the calories, and the protein would compose about 20.3% of the calories. The glycemic index would be expected to be about 32, with an expected glycemic load of about 4.5 for a 30 g serving.

VI. Analytical Protocols

A. Amino Acid Content

The total amino acid or protein content of a food is calculated after measuring the percent nitrogen content of the food by the Kjeldahl digestion method. The Kjeldahl digestion method used is AOAC Official Method 979.09, “Protein in Grains” (32.2.03; Chp. 32, pg. 23D).

i) Percent amino acid or protein is calculated by multiplying the % nitrogen by a conversion factor of 6.25:
% amino acid or protein=% N×6.25

ii) The amino acid or protein content per a given mass of food is calculated as follows:
g amino acid or protein=(mass of food)×(% amino acid or protein/100)

iii) Calories from amino acid or protein are calculated by multiplying the grams amino acid or protein by 4:
Energy from amino acid or protein (kcal)=(g amino acid or protein)×4 kcal/g

B. Amino Acid Chemical Score

The profile of essential amino acids in a food is measured after conducting an amino acid analysis on the product; see AOAC Official Method 994.12, “Amino Acids in Feeds” (4.1.11, Chp. 4, pg. 4-12). Amino acid analysis is carried out on a Beckman Model 6300 ion-exchange instrument following a 16 hr hydrolysis at 115° C. in 6 N HCl, 0.2% phenol that also contains 2 nmol norleucine. The latter serves as an internal standard to correct for losses that may occur during sample transfers, drying, etc. After hydrolysis, the HCl is evaporated and the resulting amino acids dissolved in 100 μl Beckman sample buffer that contains 2 nmol homoserine with the latter acting as a second internal standard to independently monitor transfer of the sample onto the analyzer. The instrument is calibrated with a 2 nmol mixture of amino acids and it is operated via the manufacturer's programs and with the use of their buffers. Data analysis is carried out on an external computer using Perkin Elmer/Nelson data acquisition software.

During acid hydrolysis asparagine will be converted to aspartic acid and glutamine to glutamic acid. During the HPLC analysis that follows, cysteine co-elutes with proline; and methionine sulfoxide, which is a common oxidation product found in peptides/proteins, co-elutes with aspartic acid. Hence, following normal acid hydrolysis, glutamine and asparagine are not individually quantified and it is possible that the methionine value will be low and that the aspartic acid and proline values will be somewhat high. Improved quantification of cysteine and methionine can be obtained by prior oxidation with performic acid, which converts both methionine and methionine sulfoxide to methionine sulfone and cysteine and cystine to cysteic acid. Generally, however, performic acid oxidation destroys tyrosine. Best quantification of tryptophan is obtained by hydrolysis with methanesulfonic acid (MSA) instead of hydrochloric acid. The procedure used in this instance is to carry out the hydrolysis with MSA for 16 hr at 115° C. After hydrolysis, the sample is neutralized with 0.35 M NaOH and 100 μl (50% of the sample) is then analyzed on the Beckman 6300.

To calculate the amino acid chemical score of a dietary amino acid source, the measured essential amino acid pattern of the food is compared to an ideal reference protein. The reference protein used is the recommended profile of essential amino acids (mg/g reference protein) for preschool children ages 2-5, as specified by the World Health Organization (WHO, 1985, Energy and Protein Requirements, WHO Technical Report Series 724, Geneva, 206 pp.). This ideal profile of essential amino acids is as follows:

| | mg essential amino acid/ |
|---|---|
| | g reference protein |
| Histidine | 19 |
| Isoleucine | 28 |
| Leucine | 66 |
| Lysine | 58 |
| Methionine + Cystine | 25 |
| Phenylalanine + Tyrosine | 63 |
| Threonine | 34 |
| Tryptophan | 11 |
| Valine | 35 |

The content of essential amino acids in a food (mg amino acid/g protein) is compared to the above ideal amino acid profile to identify the most limiting amino acid in the food; i.e., the amino acid in greatest deficit compared to the reference. The amino acid chemical score is then calculated based on the most limiting amino acid as follows:
Amino Acid Chemical Score=[mg limiting amino acid/g protein in food]/[mg same amino acid/g reference protein]
The amino acid chemical score of the protein or amino acid source in the food may be as high as 1.0, which would indicate that the nutritional quality of the amino acid source is equal to the ideal reference protein.

C. Digestible Fat and Digestible Saturated Fat

The content of total digestible fat and digestible saturated fat in a food is measured according to the published AOAC peer-verified method for quantifying fat in olestra-containing snack foods (JAOAC, 81, 848-868, 1998, “Determination of fat in olestra-containing savory snack products by capillary gas chromatography”, PVM 4:1995, AOAC International, Gaithersburg, Md.). The principle of this method involves extraction of the food product with chloroform-methanol solution, yielding a total lipid extract that contains the digestible fat and any non-digestible lipid. The lipid extract is hydrolyzed by lipase, yielding fatty acids from the digestible fat. The fatty acids are precipitated as calcium soaps and the isolated fatty acid soaps are converted back into fatty acids with hydrochloric acid and extracted into hexane. The isolated fatty acids are converted to methyl esters with boron trifluoride-methanol solution and quantified by capillary gas chromatography.

a.) The digestible fat and saturated fat content per a given mass of food is calculated as follows:
g digestible fat=(mass of food)×(% digestible fat/100)
g digestible saturated fat=(mass of food)×(% digestible saturated fat/100)

b.) Calories from digestible fat and saturated fat are calculated by multiplying by 9:
Energy from fat (kcal)=(g digestible fat)×9 kcal/g
Energy form saturated fat (kcal)=(g digestible saturated fat)×9 kcal/g

D. Carbohydrate

The total carbohydrate content of a food product is calculated by difference as follows:
i) % Carbohydrate=100−(% amino acid source)−(% moisture)−(% total extractable lipid)−(% ash)
ii) The carbohydrate content per a given mass of food is calculated as follows:
   g carbohydrate=(mass of food)×(% carbohydrate/100)
iii) Calories from carbohydrate are calculated as follows:
   Energy from carbohydrate (kcal)=(g carbohydrate−g dietary fiber)×3.85 kcal/g

E. Glycemic Index

The glycemic index of a food is measured in vivo using human test subjects. [The methodology is described by Wolever-American Journal of Clinical Nutrition 1981; 34: 362-366.] The test utilizes 10 healthy subjects who have fasted overnight, and compares the glycemic response of a 50 g available carbohydrate equivalent of a test food to that of a reference food (glucose GI=100). White bread may also be used as the reference food, but the resulting GI is multiplied by 1.4286 to convert it to the glucose scale. The glycemic response for each individual's reaction to the test food and reference food is determined by the area under the blood glucose (mg/dl) response curve (AUC) for a 2 hr time period. The glycemic index is calculated by 100×AUC (test)/AUC (reference). The glycemic index for the test food is then determined by averaging the respective GI values for each individual.

F. Moisture

The moisture content of a food is measured by the vacuum oven method known as AOAC Official Method 979.12, “Moisture (Loss on Drying) in Roasted Coffee” (30.1.20, Chp. 30, pg. 5).

G. Ash

The ash content of a food is measured after ignition in a furnace at about 550° C. This method is AOAC Official Method 923.03, “Ash in Flour” (32.1.05, Chp. 32, pg. 2).

H. Dietary Fiber

Dietary fiber is determined using a combination of AOAC Method for Total Dietary Fiber with the Enzymatic-HPLC Determination of Indigestible Maltodextrin in Foods (Combined AOAC Prosky—HPLC method). The procedure is fully described in U.S. patent Publication No. 2002/0015759A1.

I. Soluble Dietary Fiber:

The content of soluble dietary fiber in a food is calculated as follows:
(% soluble dietary fiber)=(% Dietary Fiber)−(% insoluble dietary fiber)

Percent Dietary Fiber is measured as described in method #7 above. The % insoluble dietary fiber content of a food is measured by the enzymatic-gravimetric method known as AOAC Official Method 991.42, “Insoluble Dietary Fiber in Food and Food Products” (32.1.16, Chp. 32, pg. 5-6).

The soluble dietary fiber content per a given mass of food is calculated as follows:
(g soluble dietary fiber)=(mass of food)×(% soluble dietary fiber/100)

J. Beta-Glucan Soluble Fiber:

The content of beta-glucan soluble fiber in a food is measured by an enzymatic-spectrophotometric method according to AOAC Official Method 992.28, “(1→3) (1→4)−Beta-D-Glucans in Oat and Barley Fractions and Ready-to-Eat Cereals” (32.2.06, Chp. 32, pg. 28-29C).

The beta-glucan soluble fiber content per a given mass of food is calculated as follows:
(g beta-glucan soluble fiber)=(mass of food)×(% beta-glucan soluble fiber/100)

K. Extractable Lipid and Calculation of Non-Digestible Lipid:

The total extractable lipid content of a food is measured by an extraction method known as AOAC Official Method 983.23, “Fat in Foods; Chloroform-Methanol Extraction Method” (45.4.02, Chp. 45, pg. 64-65). Percent total non-digestible lipid is calculated as follows:
(% non-digestible lipid)=(% extractable lipid)−(% digestible fat)

The percent digestible fat value in the above equation is derived from method #3 of Applicant's Analytical Protocols.

The non-digestible lipid content per a given mass of food is calculated as follows:
(g non-digestible lipid)=(mass of food)×(% non-digestible lipid/100)

L. Water Activity

The water activity (Aw) of a food is measured using the following protocol and instruments:

Principle: The Rotronic Hygroskop relative humidity meter uses probes, each containing a humidity sensor and a temperature sensor, to measure the equilibrium relative humidity above a sample. A sample is introduced to the probe in an air-tight chamber. After equilibrium has been reached, the relative humidity reading obtained from the instrument can be used to determine water activity (Aw).

Apparatus:
a.) Rotronic Hygroskop model DT Relative Humidity Meter
b.) Model DMS100H Humidity Cells
c.) Rotronic Sample Dishes Part # PS-14

Reagents and Solutions
a.) 35% RH standard solution (EA-35) supplied by Rotronic Instrument Corp.
b.) 50% RH standard solution (EA-50) supplied by Rotronic Instrument Corp.
c.) 65% RH standard solution (EA-65) supplied by Rotronic Instrument Corp.
d.) 80% RH standard solution (EA-80) supplied by Rotronic Instrument Corp.

Procedure
a.) Instrument Operation and Calibration
   (i) Prepare a standard curve of meter reading vs. % relative humidity (% RH) at 25° C. using the four RH standards listed in this method. The accuracy of the calibration curves should be checked periodically using the relative humidity standard solutions.
   (ii) Carefully open a vial of RH standard solution and pour the contents into a plastic sample dish. Place the sample dish containing the standard solution into cell #1 of the instrument and seal tightly. Allow at least one hour for the meter reading to stabilize. Record the meter and temperature readings.
   (iii) Repeat step 2 for the other humidity standards.
   (iv) Prepare a standard curve by plotting the meter readings against the known RH of the standards.
   (v) Prepare a standard curve for cell #2 in the same fashion.
b.) Sample Analysis
   (i) Select a humidity cell to use for the analysis. Wipe clean the inner surfaces of the cell with a paper towel. This will remove anything left over from a previous sample.
   (ii) Obtain a sample of food product. Samples must be at room temperature before the analysis can be run.
   (iii) Place the sample into a plastic sample dish. The sample may need to be crushed or ground (eg. crackers) to fit into the dish. The dish should be filled as much as possible with the sample.
   (iv) Place the sample dish into a cell and place the cell into the instrument.

Keeping the cell level, seal the cell tightly to the instrument.
(v) Allow at least 0.5 hr for meter reading to stabilize. Trend lights on both the RH meter and temperature meter should not be lit when recording a reading. If either is lit at the end of 0.5 hr, wait until they go out before recording the meter readings.
(vi) Record the RH and temperature meter readings.
(iiv) Convert the RH meter reading to the equilibrium % RH using the previously prepared standard curve for the cell used. Convert the equilibrium relative humidity to Aw.
c.) Water activity (Aw)Calculations: Aw=% RH/100

All AOAC (Association of Official Analytical Chemists) published methods can be found in the following reference, which is incorporated by reference in its entirety:

AOAC International, Official Methods of Analysis, P. Cunniff (ed.), 16^{th} edition, 5^{th} Revision, 1999, Gaithersburg, Md.

All documents cited in the Detailed Description section are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A snack food having a water activity of less than 0.90; and comprising, on a 30-gram basis:
a) a glycemic index of not more than about 55;
b) at least about 5 g of an amino acid source;
c) not more than about 3 g of a digestible fat; and
d) a carbohydrate that provides at least about 2.5 g of dietary fiber.

2. The snack food of claim 1, having a glycemic load of not more than about 6.

3. The snack food of claim 2, having a glycemic load of not more than about 4.

4. The snack food of claim 3, having a glycemic load of not more than about 2.

5. The snack food of claim 1, having a glycemic index of not more than about 40.

6. The snack food of claim 1, having a glycemic index of not more than about 30.

7. The snack food of claim 1, having less than about 2 g of digestible fat.

8. The snack food of claim 1, having a water activity not more than about 80.

9. A snack food having a water activity of less than 0.90; and comprising, on a 30 gram basis:
a) a glycemic index of not more than about 40;
b) at least about 5 g of an amino acid source;
c) not more than about 2 g of a digestible fat;
d) a carbohydrate that provides at least about 2.5 g of dietary fiber; and
e) a glycemic load of not more than about 6.

10. The snack food of claim 9, having a glycemic index of not more than about 30.

11. The snack food of claim 9, having less than about 2 g of digestible saturated fat.

12. The snack food of claim 9, having a glycemic load of not more than about 4.

13. The snack food of claim 9, having a water activity not more than about 80.

14. A snack food having a water activity of less than 0.90; and comprising, on a 100 kcal reference basis:
a) a glycemic index of not more than about 55;
b) at least 5 g of an amino acid source;
c) less than 3 g of a digestible fat; and
d) a carbohydrate that provides at least about 2.5 g of dietary fiber.

15. The snack food of claim 14, having a glycemic load of not more than about 6.

16. The snack food of claim 15, having a glycemic load of not more than about 4.

17. The snack food of claim 14, having a glycemic index of not more than about 40.

18. The snack food of claim 14, having a glycemic index of not more than about 30.

19. The snack food of claim 14, comprising, on a 100 kcal reference basis:
a) a glycemic index of not more than about 40;
b) at least about 5 g of an amino acid source;
c) not more than about 2 g of a digestible fat;
d) a carbohydrate that provides at least about 2.5 g of dietary fiber; and
e) a glycemic load of not more than about 6.

20. The snack food of claim 19, having a glycemic index of not more than about 30.

21. The snack food of claim 19, having a glycemic load of not more than about 4.
